(19) United States
(12) Patent Application Publication
(10) Pub. No.: US 2026/0204865 A1
(43) Pub. Date: Jul. 16, 2026

(54) LIGHT-EMITTING DEVICE

(71) Applicant: Nippon Telegraph and Telephone Corporation, Tokyo (JP)

(72) Inventors: Ryuichi Ota, Tokyo (JP); Xuejun Xu, Tokyo (JP); Tomohiro Inaba, Tokyo (JP); Haruki Sanada, Tokyo (JP); Hajime Okamoto, Tokyo (JP)

(21) Appl. No.: 18/865,915

(22) PCT Filed: Jul. 25, 2022
(86) PCT No.: PCT/JP2022/028590

§ 371 Date: Nov. 14, 2024

(51) Int. Cl. H01S 3/131; H01S 3/02; H01S 3/09; H01S 3/16

(52) U.S. Cl. CPC H01S 3/131; H01S 3/025; H01S 3/0906; H01S 3/1603

(57) ABSTRACT

A light-emitting element includes comb-shaped electrodes on a surface of a substrate made of a crystal containing a rare earth element as a light-emitting center. The comb-shaped electrodes are formed on a surface of zinc oxide thin films formed on the substrate.

### CROSS-REFERENCE TO RELATED APPLICATIONS

This application is a national phase entry of PCT Application No. PCT/JP2022/028590, filed on Jul. 25, 2022, which application is hereby incorporated herein by reference.

### TECHNICAL FIELD

The present invention relates to a light-emitting element including a rare earth element as a light-emitting center.

### BACKGROUND

Light-emitting centers of rare earth elements are used in various optical communication devices such as highly efficient lasers and amplifiers because non-radiative relaxations are less likely to occur and light can be emitted in a communication wavelength band. In recent years, a technique for fabricating an optical waveguide or a resonator containing a rare earth element on a silicon substrate has been established, and research and development for a light source of an on-chip photonic integrated circuit has also been advanced (Non Patent Literature 1). However, since it is difficult to control the light-emitting center of the rare earth element by an external electric field, a separate modulator has been needed in order to perform light control such as intensity modulation.

As a method for dynamically controlling the light emission characteristics of the rare earth element, a method using oscillation strain has been disclosed (Non Patent Literature 2). Non Patent Literature 2 reports a method for controlling an emission wavelength using oscillation strain by processing a solid crystal containing a rare earth element into a cantilevered oscillator structure. However, fabrication of the cantilevered structure requires three-dimensional processing using an ion beam, and this makes it difficult to fabricate a large number of elements at a time. For this reason, it has been difficult to increase the degree of integration and scale of elements required for application to an on-chip photonic integrated circuit.

### CITATION LIST

### Non Patent Literature

Non Patent Literature 1: X. Xu, et al., “Low-loss erbium-incorporated rare-earth oxide waveguides on Si with bound states in the continuum and the large optical signal enhancement in them”, Optics Express, Vol. 29, No. 25, 41132, 2021
Non Patent Literature 2: R. Ohta, et al., “Rare-Earth-Mediated Optomechanical System in the Reversed Dissipation Regime”, Physical Review Letters, 126, 047404, 2021

### SUMMARY

### Technical Problem

Embodiments of the present invention have been made to solve the above problems, and an object of embodiments of the present invention is to provide a light-emitting element that can modulate the emission wavelength and the emission intensity of a light-emitting center and is easily applied to a photonic integrated circuit.

### Solution to Problem

A light-emitting element of the present invention includes a comb-shaped electrode on a surface of a solid material containing a rare earth element as a light-emitting center.

### Advantageous Effects

In embodiments of the present invention, a comb-shaped electrode is provided on a surface of a solid material containing a rare earth element as a light-emitting center and an electric signal is applied to the comb-shaped electrode, whereby the emission wavelength and the emission intensity of the light-emitting center can be modulated. In addition, in embodiments of the present invention, it is possible to easily increase the degree of integration and scale of elements required for application to a photonic integrated circuit.

### BRIEF DESCRIPTION OF THE DRAWINGS

FIG. 1 is a perspective view illustrating a configuration of a light-emitting element according to a first embodiment of the present invention.

FIG. 2 is a plan view of a comb-shaped electrode according to the first embodiment of the present invention.

FIG. 3 is a diagram illustrating a transmission signal spectrum across comb-shaped electrodes.

FIG. 4 is a diagram illustrating a relationship between a frequency of an electric signal applied to the comb-shaped electrode and a light absorption spectrum of erbium.

FIG. 5 is a diagram illustrating a temporal change in intensity of light output from the light-emitting element.

FIG. 6 is a perspective view illustrating a configuration of a light-emitting element according to a second embodiment of the present invention.

FIG. 7 is a perspective view illustrating a configuration of a light-emitting element according to a third embodiment of the present invention.

### DETAILED DESCRIPTION OF ILLUSTRATIVE EMBODIMENTS

When a comb-shaped electrode is placed on a solid material having piezoelectric characteristics and an AC voltage is applied to the electrode, an elastic wave is generated on the surface of the solid material at a frequency corresponding to the distance between the comb teeth. Embodiments of the present invention provide a structure capable of controlling light emitted from a light-emitting center of a rare earth element using the surface elastic wave.

For example, a solid material containing a rare earth element such as erbium (Er) is often a non-piezoelectric material, but a surface elastic wave can be generated by forming an oriented piezoelectric film. With the strain effect and the thermal effect of the surface elastic wave, it is possible to modulate the emission wavelength and the emission intensity of the light-emitting center. By fabricating an oscillation resonance mechanism having a concave and convex structure that is coincide with the wavelength and period of the surface elastic wave on the surface of the solid material, the surface elastic wave can be confined, and the strain effect of the surface elastic wave can be increased. In addition, by removing a part of the piezoelectric film or incorporating an optical waveguide or an optical resonator, light extraction efficiency and emission efficiency can be improved.

The structure of the present invention can be fabricated by a typical semiconductor process such as photolithography or metal vapor deposition, and can easily increase the degree of integration and scale of elements required for application to a photonic integrated circuit.

### First Embodiment

Hereinafter, embodiments of the present invention will be described with reference to the drawings. Note that the present invention is not limited to the following embodiments.

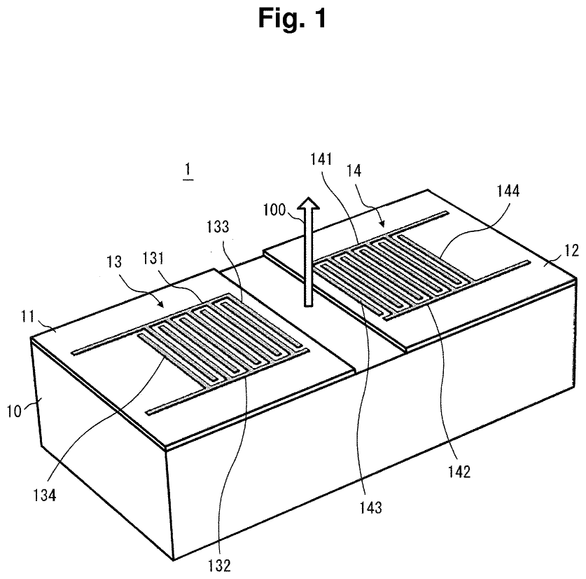

FIG. 1 is a perspective view illustrating a configuration of a light-emitting element according to the present embodiment. A light-emitting element 1 includes a substrate 10 made of yttrium silicate (Y₂SiO₅) crystal doped with Er as a light-emitting center, zinc oxide (ZnO) thin films 11, 12 having a thickness of 500 μm formed on the substrate 10, and comb-shaped electrodes 13, 14 made of metal such as aluminum (Al) having a thickness of 50 nm formed on the surfaces of the ZnO thin films 11, 12. Reference numeral 100 in FIG. 1 represents light output from the light-emitting element 1.

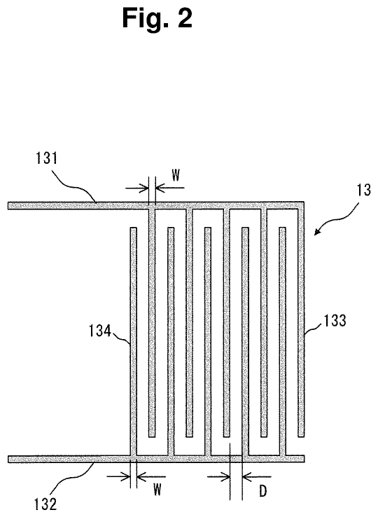

FIG. 2 is a plan view of the comb-shaped electrode 13. The comb-shaped electrode 13 includes two comb-shaped electrode portions 131, 132 facing each other. The electrode portions 131, 132 include a plurality of electrode fingers 133, 134, respectively, protruding toward the opposite electrode portions. A width W of the electrode fingers 133, 134 is 500 μm, and a distance D between an electrode finger 133 and an electrode finger 134 is 4 μm.

Similarly, the comb-shaped electrode 14 includes two comb-shaped electrode portions 141, 142 facing each other. The electrode portions 141, 142 include a plurality of electrode fingers 143, 144, respectively, protruding toward the opposite electrode portions. Similarly, as in the comb-shaped electrode 13, the width of the electrode fingers 143, 144 is 500 μm, and the distance between an electrode finger 143 and an electrode finger 144 is 4 μm.

To fabricate the light-emitting element 1 as illustrated in FIG. 1, a ZnO thin film is formed on the substrate 10, and the comb-shaped electrodes 13, 14 are formed on the ZnO thin film. The ZnO thin film is oriented in the c-axis direction. Finally, the ZnO thin film between the comb-shaped electrodes 13 and 14 is removed by wet etching to separate the ZnO thin film 11 under the comb-shaped electrode 13 from the ZnO thin film 12 under the comb-shaped electrode 14. Output light of the light-emitting element 1 can be extracted from a region from which the ZnO thin film is removed, and excitation light can be input to the region from which the ZnO thin film is removed.

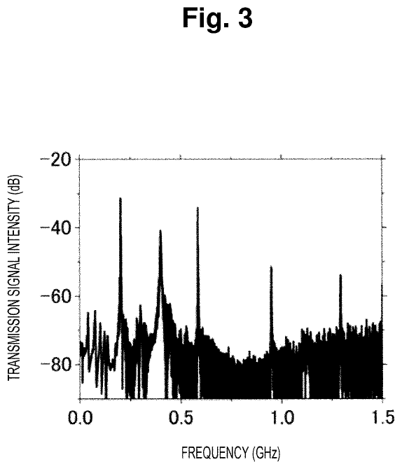

A transmission spectrum of an electric signal across the comb-shaped electrodes 13 and 14 is illustrated in FIG. 3. The transmission spectrum in FIG. 3 is obtained by applying an AC signal across the electrode portions 131 and 132 of the comb-shaped electrode 13 from an external power source to generate a surface elastic wave, and detecting an electric signal across the electrode portions 141 and 142 of the comb-shaped electrode 14. Although the comb-shaped electrodes 13 and 14 were electrically separated from each other, it was confirmed that there was signal propagation at frequencies of 200 MHz, 580 MHz, 950 MHz, and 1.3 GHz. Signal propagation indicates that electric signals of these frequencies are converted into surface elastic waves by the comb-shaped electrode 13.

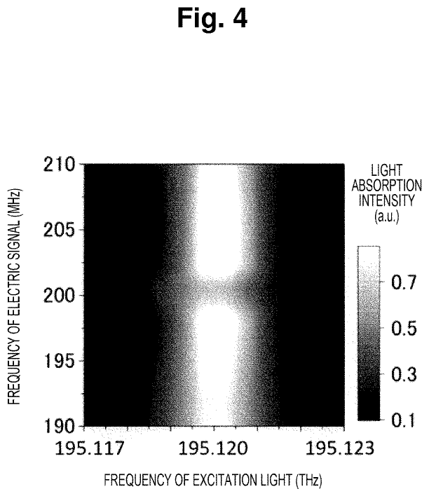

Next, a change in the optical characteristics of Er that appeared by exciting the surface elastic wave was evaluated. FIG. 4 illustrates a relationship between a frequency of an electric signal applied to the comb-shaped electrode 13 and an absorption spectrum of Er. As the excitation light emitted to the light-emitting element 1, light resonating at the light-emitting center may be emitted. Here, the light-emitting element 1 is irradiated with excitation light at frequencies of 195.117 THz to 195.123 THz from an external light source, and the frequency of an AC signal applied from the external power source to the comb-shaped electrode 13 is changed from 210 MHz to 190 MHz.

The example of FIG. 4 indicates that the light absorption intensity decreases from white toward black, and indicates that when the frequency of the signal applied to the comb-shaped electrode 13 coincides with 200 MHz, the light absorption at 195.120 THz significantly decreases. From the results of FIG. 4, it can be seen that the emission intensity of Er can be controlled by the electric signal by using the surface elastic wave.

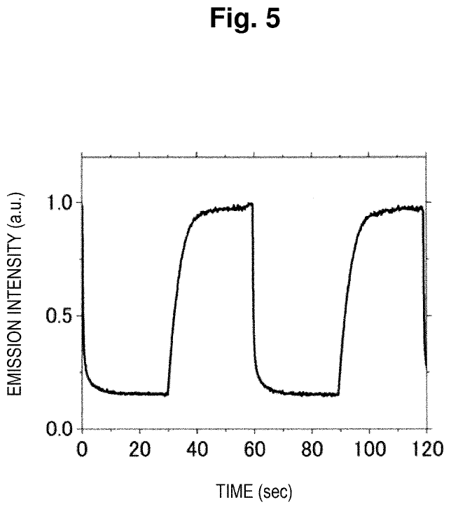

FIG. 5 illustrates a temporal change in the intensity of light output from the light-emitting element 1 when an electric signal obtained by modulating the intensity of a carrier wave having a carrier frequency of 200 MHz with a square wave having a period of 60 sec is applied to the comb-shaped electrode 13. By applying a voltage of about 10.8 V to the comb-shaped electrode 13, approximately 8.2 dB of intensity-modulated light emission was confirmed.

### Second Embodiment

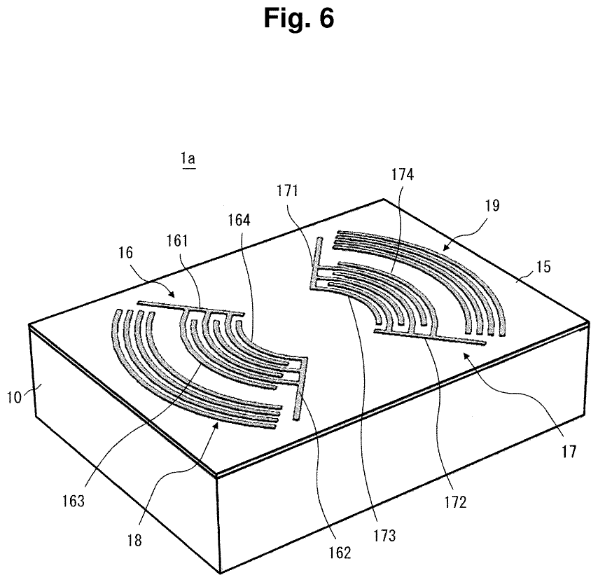

FIG. 6 is a perspective view illustrating a configuration of a light-emitting element according to a second embodiment of the present invention. A light-emitting element 1a of the present embodiment includes the substrate 10, a ZnO thin film 15 formed on the substrate 10, comb-shaped electrodes 16, 17 made of metal such as Al formed on the surface of the ZnO thin film 15, and Bragg reflectors 18, 19 (oscillation resonance mechanism) made of metal such as Al formed on the surface of the ZnO thin film 15 so as to surround the comb-shaped electrodes 16, 17.

In the present embodiment, curved comb-shaped electrodes 16, 17 were formed on the substrate 10 and the ZnO thin film 15 similar to those in the first embodiment. The comb-shaped electrode 16 includes two comb-shaped electrode portions 161, 162 facing each other. The electrode portions 161, 162 include a plurality of electrode fingers 163, 164, respectively, protruding toward the opposite electrode portions. Similarly, the comb-shaped electrode 17 includes two comb-shaped electrode portions 171, 172 facing each other. The electrode portions 171, 172 include a plurality of electrode fingers 173, 174, respectively, protruding toward the opposite electrode portions.

In the present embodiment, a plurality of thin metal wires is disposed at outer sides of the comb-shaped electrodes 16, 17 on the surface of the ZnO thin film 15 to form the Bragg reflectors 18, 19. The width of the thin metal wires is the same as the width of the electrode fingers 163, 164, 173, 174. The distance between the thin metal wires is the same as the distance between the electrode fingers 163 and 164 and the distance between the electrode fingers 173 and 174.

The surface elastic wave generated by applying an electric signal to the comb-shaped electrode 16 or 17 is reflected by the Bragg reflectors 18, 19 and concentrated in the central portion of the substrate surrounded by the Bragg reflectors 18, 19. In the present embodiment, since the surface elastic wave can be confined by the Bragg reflectors 18, 19, a Q factor indicating the confinement performance can be a high value, and the strain effect of the surface elastic wave can be increased as compared with the first embodiment. With the above configuration, in the present embodiment, it is possible to increase the modulation amplitude of light and reduce the applied voltage.

In the present embodiment, Bragg reflectors formed of thin metal wires are used as an oscillation resonance mechanism for spatially confining a surface elastic wave, but the present invention is not limited thereto, and various other oscillation resonance mechanisms can be used.

### Third Embodiment

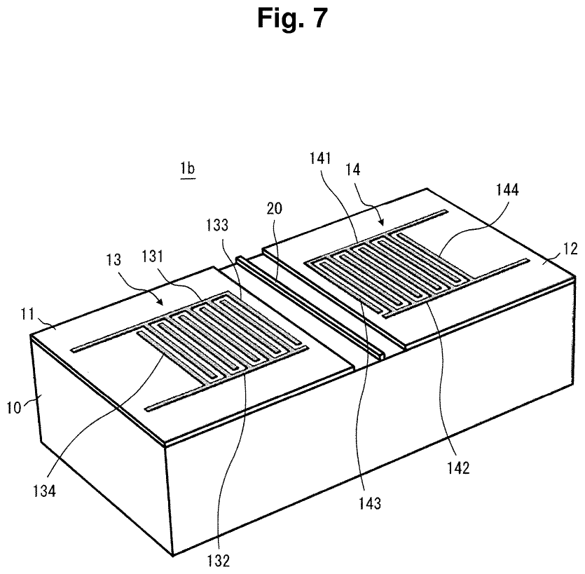

FIG. 7 is a perspective view illustrating a configuration of a light-emitting element according to a third embodiment of the present invention. In a light-emitting element 1b of the present embodiment, a thin wire optical waveguide 20 made of silicon nitride (Si₃N₄) is formed on a surface of the substrate 10 between the comb-shaped electrodes 13 and 14 of the first embodiment. The width of the optical waveguide 20 is 1 μm and the thickness thereof is 500 nm.

In the structure of the present embodiment, since part of light propagating through the optical waveguide 20 leaks to the substrate 10, efficient optical excitation to Er in the vicinity of the substrate surface can be performed. In addition, output light of the light-emitting element 1b can be extracted via the optical waveguide 20. Furthermore, in the present embodiment, the output light can be guided to other optical elements such as a demultiplexer and a detector on the same chip as the light-emitting element 1b via the optical waveguide 20, and a structure suitable for application to a photonic integrated circuit can be obtained.

In the present embodiment, a thin wire optical waveguide is used as the optical waveguide, but optical waveguides or optical resonators having other various shapes can also be used.

In the second embodiment, the ZnO thin film 15 between the comb-shaped electrodes 16 and 17 may be removed and an optical waveguide or an optical resonator may be formed on the surface of the substrate 10 between the comb-shaped electrodes 16 and 17.

In the first to third embodiments, a ZnO thin film as a piezoelectric film is formed on a Y₂SiO₅ crystal and light emission of Er is controlled, but the present invention is not limited to a specific crystal, a specific piezoelectric film, or a specific rare earth element. In the first to third embodiments, the comb-shaped electrodes including the linear electrode fingers and the curved electrode fingers are used, but the present invention is not limited to a comb-shaped electrode having a specific shape. In the first to third embodiments, two electrodes are provided as in the examples of the comb-shaped electrodes 13, 14 or the comb-shaped electrodes 16, 17. However, since a surface elastic wave can be generated with an electrode for excitation, the number of comb-shaped electrodes may be one.

Some or all of the above-described embodiments may be described as the following supplementary notes, but are not limited to the following.

Supplementary note 1—A light-emitting element of embodiments of the present invention includes a comb-shaped electrode on a surface of a solid material containing a rare earth element as a light-emitting center.

Supplementary note 2—In the light-emitting element according to Supplementary note 1, the comb-shaped electrode is formed on a surface of a piezoelectric film formed on the solid material.

Supplementary note 3—The light-emitting element according to Supplementary note 1 further includes an oscillation resonance mechanism formed on the surface of the solid material so as to surround the comb-shaped electrode and configured to reflect a surface elastic wave from the comb-shaped electrode.

Supplementary note 4—In the light-emitting element according to Supplementary note 3, the comb-shaped electrode and the oscillation resonance mechanism are formed on a surface of a piezoelectric film formed on the solid material.

Supplementary note 5—The light-emitting element according to Supplementary note 1 further includes an optical waveguide or an optical resonator on the surface of the solid material.

Supplementary note 6—In the light-emitting element according to Supplementary note 5, the comb-shaped electrode is formed on a surface of a piezoelectric film formed on the solid material, and the optical waveguide or the optical resonator is formed on the surface of the solid material in a region from which a part of the piezoelectric film near the comb-shaped electrode is removed.

Supplementary note 7—The light-emitting element according to Supplementary note 1 further includes an oscillation resonance mechanism formed on the surface of the solid material so as to surround the comb-shaped electrode and configured to reflect a surface elastic wave from the comb-shaped electrode, and an optical waveguide or an optical resonator formed on the surface of the solid material.

Supplementary note 8—In the light-emitting element according to Supplementary note 7, the comb-shaped electrode and the oscillation resonance mechanism are formed on a surface of a piezoelectric film formed on the solid material, and the optical waveguide or the optical resonator is formed on the surface of the solid material in a region from which a part of the piezoelectric film near the comb-shaped electrode is removed.

### INDUSTRIAL APPLICABILITY

Embodiments of the present invention can be applied to a light-emitting element.

Reference Signs List

| 1, 1a, 1b | Light-emitting element |
|---|---|
| 10 | Substrate |
| 11, 12, 15 | Zinc oxide thin film |
| 13, 14, 16, 17 | Comb-shaped electrode |
| 18, 19 | Bragg reflector |
| 20 | Thin wire optical waveguide |
| 131, 132, 141, 142, 161, 162, 171, 172 | Electrode portion |
| 133, 134, 143, 144, 163, 164, 173, 174 | Electrode finger |

1-8. (canceled)

9. A light-emitting element comprising:
a solid material containing a rare earth element as a light-emitting center; and
a comb-shaped electrode on a surface of the solid material.

10. The light-emitting element according to claim 9, further comprising:
a piezoelectric film between the comb-shaped electrode and the solid material.

11. The light-emitting element according to claim 9, further comprising:
an oscillation resonance mechanism on the surface of the solid material and surrounding the comb-shaped electrode, the oscillation resonance mechanism being configured to reflect a surface elastic wave from the comb-shaped electrode.

12. The light-emitting element according to claim 11, wherein:
the comb-shaped electrode and the oscillation resonance mechanism each disposed on a surface of a piezoelectric film on the solid material.

13. The light-emitting element according to claim 9, further comprising:
an optical waveguide or an optical resonator on the surface of the solid material.

14. The light-emitting element according to claim 13, wherein:
the comb-shaped electrode is disposed on a surface of a piezoelectric film on the solid material, and
the optical waveguide or the optical resonator is disposed on the surface of the solid material free of the piezoelectric film.

15. The light-emitting element according to claim 9, further comprising:
an oscillation resonance mechanism on the surface of the solid material and surrounding the comb-shaped electrode, the oscillation resonance mechanism being configured to reflect a surface elastic wave from the comb-shaped electrode; and
an optical waveguide or an optical resonator on the surface of the solid material.

16. The light-emitting element according to claim 15, wherein:
the comb-shaped electrode and the oscillation resonance mechanism are disposed on a surface of a piezoelectric film on the solid material, and
the optical waveguide or the optical resonator is formed on the surface of the solid material free of the piezoelectric film.

17. A light-emitting element comprising:
a solid material containing a rare earth element as a light-emitting center;
a piezoelectric film over a surface of the solid material;
a comb-shaped electrode overlapping the piezoelectric film; and
an oscillation resonance mechanism over the surface of the solid material and surrounding the comb-shaped electrode.

18. The light-emitting element according to claim 17, wherein the oscillating resonance mechanism overlaps the piezoelectric film.

19. The light-emitting element according to claim 17, wherein the oscillating resonance mechanism is disposed on surface of the solid material that is free of the piezoelectric film.

20. The light-emitting element according to claim 17, wherein the oscillation resonance mechanism being configured to reflect a surface elastic wave from the comb-shaped electrode.
